(19) United States
(12) Patent Application Publication
(10) Pub. No.: US 2010/0077188 A1
(43) Pub. Date: Mar. 25, 2010

(54) EMERGENCY FILE PROTECTION SYSTEM FOR ELECTRONIC DEVICES

(75) Inventors: Kerry GRAHAM, Raleigh, NC (US); William Bramante, Apex, NC (US); David Hoover, Cary, NC (US)

Correspondence Address: Williams Mullen, 222 Central Park Ave, Suite 1700, Virginia Beach, VA, 23462, US

(73) Assignee: 3 ESPLANADE DU FONCET, CEDEX (FR)

(21) Appl. No.: 12/237,518

(22) Filed: Sep. 25, 2008

(51) Int. Cl. G06F 9/30

(52) U.S. Cl. 712/244; 712/E09.016

(57) ABSTRACT

Disclosed is a method, system, and computer readable medium for completing critical write functions to a non-volatile memory (NVM) system within an electronic device upon experiencing a sudden or unexpected loss of the main power to the electronic device. A sudden loss of main external power is detected and determined if the loss of power crosses a minimum threshold level. If it does, an interrupt is generated to prevent new write requests. One embodiment uses a software interrupt and another embodiment uses a hardware interrupt. A switch over to a short term reserve internal power source occurs and the NVM write function in progress at the time of the power loss is completed. Upon completion of the NVM write operation, less critical shutdown activities can commence.

### BACKGROUND

Electronic devices often have internal storage of important information that can be modified and saved during normal operations. For the purpose of description in this invention, this storage shall be termed “Non-Volatile Memory” or “NVM”. In certain situations, NVM integrity can be at risk. For example, if power to the device is removed during a write operation, the memory could be corrupted or compromised. This invention describes a method to protect an electronic device's NVM in the case of power being unexpectedly removed. In many portable electronic devices, size and cost are critical factors, so a large battery backup on the device would not be acceptable.

What is needed is an NVM system that can complete any outstanding write requests following a sudden unexpected main power loss using a small unobtrusive secondary short-term secondary power source.

### SUMMARY

Disclosed is a method, system, and computer readable medium for completing critical write functions to a non-volatile memory (NVM) system within an electronic device upon experiencing a sudden or unexpected loss of the main power to the electronic device. A sudden loss of main external power is detected and determined if the loss of power crosses a minimum threshold level. If it does, an interrupt is generated to prevent new write requests. One embodiment uses a software interrupt and another embodiment uses a hardware interrupt. A switch over to a short term reserve internal power source occurs and the NVM write function in progress at the time of the power loss is completed. Upon completion of the NVM write operation, less critical shutdown activities can commence.

### BRIEF DESCRIPTION OF THE DRAWINGS

FIG. 1 is a block diagram that illustrates one implementation of handling existing write operation when external power is suddenly lost.

FIG. 2 is a block diagram that illustrates another implementation of handling existing write operation when external power is suddenly lost.

FIG. 3 is a logic diagram that illustrates one implementation of handling existing write operation when external power is suddenly lost.

FIG. 4 is a logic diagram that illustrates another implementation of handling existing write operation when external power is suddenly lost.

### DETAILED DESCRIPTION OF THE INVENTION

In a normal situation, an electronic device will be powered down in an organized manner, including the saving of critical data as well as other shutdown activities. In the case of a RF cellular device, the device is expected to inform the network that it is shutting down, which could consume a significant amount of time. In certain situations power could be removed abruptly and unexpectedly. If the device is in the process of writing data to non-volatile memory at this time, the data could become corrupted. In order to protect data in this situation, the device can be equipped with a small capacitor or other device (“short-term reserve internal power”) that can provide a very short amount of voltage and current (for minimal cost and size) that will allow the device to complete its most critical file system operations in an organized manner. The device can detect the loss of external power by using a hardware circuit. When the device detects this situation, it can inform the device's software. The software can complete the critical file system operations with highest priority, and then prevent any further file system accesses before internal power is lost. Less critical operations (such as network access and notifications) can be attempted after all critical file system writes have been completed.

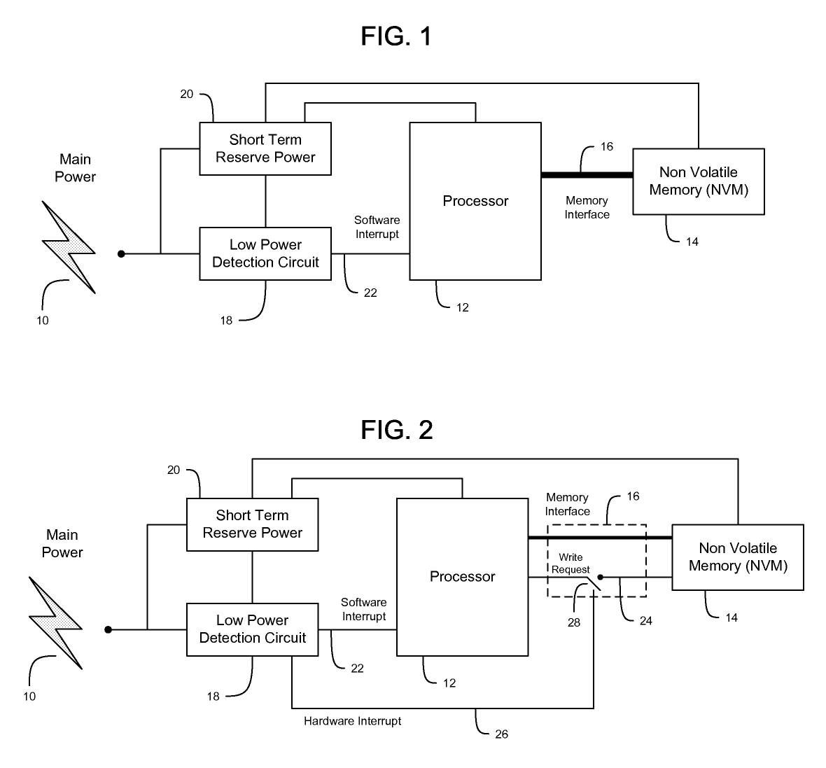

FIG. 1 is a block diagram that illustrates one implementation of handling existing write operation when external power 10 is suddenly lost. An external main power source 10 is responsible for powering the entire electronic device and all of its internal components including a processor 12 and a non-volatile memory system (NVM) 14. When this power source 10 is suddenly removed from the electronic device a low power detection circuit 18 detects the absence of power. A short-term reserve power source 20 such as a charged capacitor is automatically invoked and a software interrupt 22 is generated and sent to the processor 12. The processor 12 responds to software interrupt 22 by blocking any new write requests on the memory interface 16 to the non volatile memory 14 and initiating a system shutdown. The short-term reserve power source 20 provides enough power to allow an existing current write operation on the memory interface 16 to complete before the short term reserve power 20 is depleted.

FIG. 2 is a block diagram that illustrates another implementation of handling existing write operation when external power 10 is suddenly lost. Just as described with respect to FIG. 1 above, an external main power source 10 is responsible for powering the entire electronic device and all of its internal components including a processor 12 and a non-volatile memory system (NVM) 14. When this power source 10 is suddenly removed from the electronic device a low power detection circuit 18 detects the absence of power. A short-term reserve power source 20 such as a charged capacitor is automatically invoked and a software interrupt 22 is generated and sent to the processor 12. The processor 12 responds to software interrupt 22 by blocking any new write requests on memory interface 16 to the non volatile memory 14 and initiating a system sutdown. In addition, the memory interface 16 is also disabled via a hardware interrupt 26. This is achieved by gating 28 the write request line 24 between the processor 12 and the non-volatile memory 14. The short-term reserve power source 20 provides enough power to allow an existing current write operation on the memory interface 16 to complete before the short term reserve power 20 is depleted. Using a hardware interrupt 26 is faster than waiting for the software interrupt 22 to be acted on by the processor 12.

The disconnection method used for the write request line 24 is synchronized with other control signals between the processor 12 and the non-volatile memory 14 to ensure that any write operation that is in progress when the loss of power event occurs is allowed to complete.

A further enhancement to the hardware interrupt method would be to include hardware interrupts for disabling other internal components that require power so as to prolong the life of the short term power source 20 as much as possible for critical functions. In a cellular device, for instance, this would include disabling the RF transceiver and power amplifiers as these components consume significant amounts of power. Disabling these components via hardware interrupt is inconsequential to the overall device as these components are about to lose power anyway and disabling them moments earlier would not be additionally detrimental.

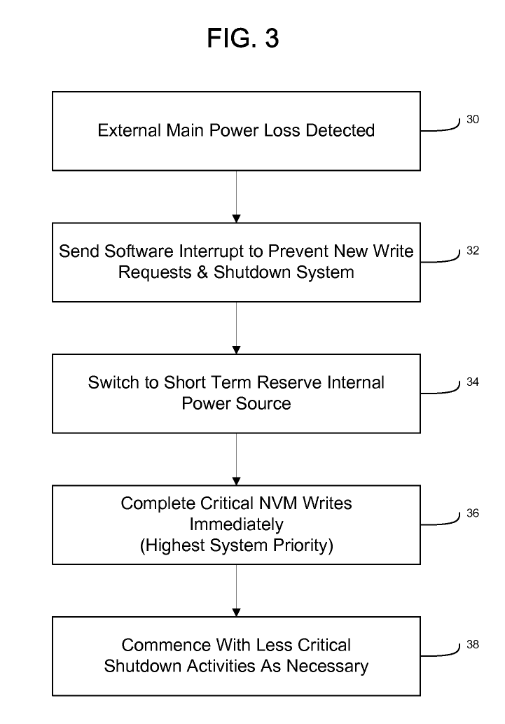

FIG. 3 is a logic diagram that illustrates one implementation of handling existing write operation when external power is suddenly lost. This embodiment uses a software interrupt to help complete an existing write operation during a power loss event. Low power detection circuitry monitors system power and detects when the main external power drops below a threshold level 30. Upon detection of a power drop below the threshold level, a software interrupt is generated to prevent any new write requests 32. Power is switched over to the short term reserve internal power source 34. Using the reserve power source, critical NVM writes that were already in progress are completed 36. Upon completion of the critical NVM writes, the system can commence with less critical shutdown activities as necessary 38 and until the short term power source is depleted.

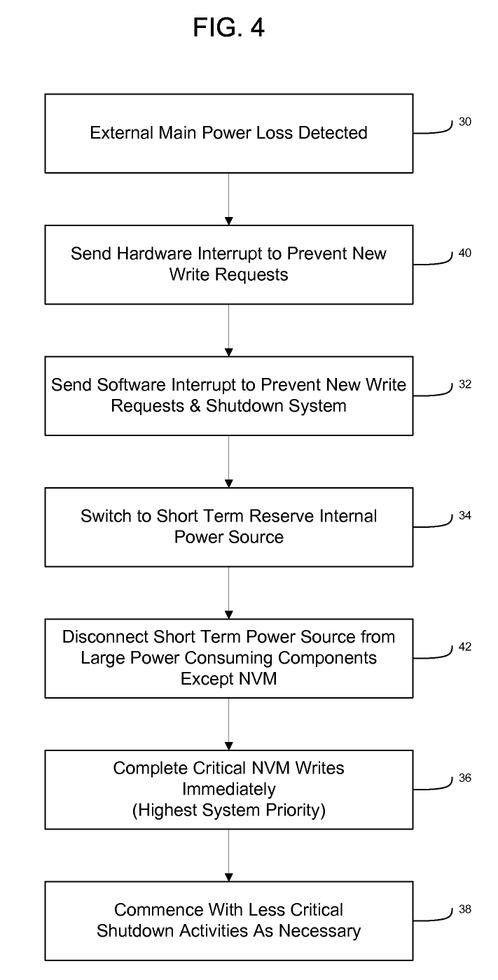

FIG. 4 is a logic diagram that illustrates another implementation of handling existing write operations when external power is suddenly lost. This embodiment uses a hardware interrupt to help complete an existing write operation during a power loss event. Low power detection circuitry monitors system power and detects when the main external power drops below a threshold level 30. Upon detection of a power drop below the threshold level, a hardware interrupt is generated to prevent any new write requests 40. In addition, a software interrupt may also be generated to prevent new write requests and to shutdown the system 32. Power is switched over to the short term reserve internal power source 34. In a further effort to ensure that enough of the short term reserve power is dedicated to the completion of the NVM write, similar hardware interrupts can be applied to disable other large power consuming components within the device except, of course, for the non-volatile memory system 42. Using the reserve power source, critical NVM writes that were already in progress are completed 36. Upon completion of the critical NVM writes, the system can commence with less critical shutdown activities 38 as necessary and until the short term power source is depleted.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present invention may be presented and responded to via a graphical user interface (GUI) presented on the display of the mobile communications device or the like. Prompts may also be audible, vibrating, etc.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method of completing critical write functions to a non-volatile memory (NVM) system within an electronic device upon experiencing a sudden or unexpected loss of the main power to the electronic device, the method comprising:
detecting a sudden loss of power;
determining if the loss of power within the main external power supply crosses a minimum threshold level and when it does:
generating an interrupt to prevent new write requests;
switching to a short term reserve internal power source; and
completing the NVM write function in progress at the time of the power loss.

2. The method of claim 1 wherein the interrupt is a software interrupt.

3. The method of claim 1 wherein the interrupt is a hardware interrupt.

4. The method of claim 1 further comprising commencing with less critical shutdown activities upon completion of the NVM write operation.

5. The method of claim 1 further comprising disabling other power consuming components of the device except the non-volatile memory system.

6. A computer readable medium storing a computer program product for completing critical write functions to a non-volatile memory (NVM) system within an electronic device upon experiencing a sudden or unexpected loss of the main power to the electronic device, the computer readable medium comprising:
computer program code for detecting a sudden loss of power within the main external power supply;
computer program code for determining if the loss of power within the main external power supply crosses a minimum threshold level and when it does:
computer program code for generating an interrupt to prevent new write requests;
computer program code for switching to a short term reserve internal power source; and
computer program code for completing the NVM write function in progress at the time of the power loss.

7. The computer readable medium of claim 6 wherein the interrupt is a software interrupt.

8. The computer readable medium of claim 6 wherein the interrupt is a hardware interrupt.

9. The computer readable medium of claim 6 further comprising computer program code for commencing with less critical shutdown activities upon completion of the NVM write operation.

10. The computer readable medium of claim 6 further comprising computer program code for disabling other power consuming components of the device except the non-volatile memory system.

11. A system for completing critical write functions to a non-volatile memory (NVM) system within an electronic device upon experiencing a sudden or unexpected loss of the main power to the electronic device, the system comprising:
a processor for controlling the operation of the wireless device;
a low power detection circuit for detecting when a main external power source dips below threshold level;
a short term reserve power source for providing power to the processor and NVM system to complete a write operation when the main external power source dips below the threshold level; and
a non-volatile memory system, wherein
an interrupt is generated when the main external power source dips below the threshold level to prevent additional write requests from occurring; and
an existing write operation is completed using power from the short term reserve power source.

12. The system of claim 11 wherein the short term reserve power source is comprised of a charged capacitor.

13. The system of claim 11 wherein the interrupt is a software interrupt.

14. The system of claim 11 wherein the interrupt is a hardware interrupt.

15. The system of claim 11 wherein less critical shutdown activities are commenced using power from the short term reserve power source upon completion of the NVM write operation.

16. The system of claim 11 wherein other power consuming components of the device except the non-volatile memory system are disabled upon detecting when the main external power source dips below threshold level.
